(19) United States
(12) Patent Application Publication
(10) Pub. No.: US 2003/0169210 A1
(43) Pub. Date: Sep. 11, 2003

(54) Novel feed structure for quadrifilar helix antenna

(76) Inventors: R. Michael Barts, Christiansburg, VA (US); Warren L. Stutzman, Blacksburg, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/346,163

(22) Filed: Jan. 17, 2003

Related U.S. Application Data
(60) Provisional application No. 60/349,228, filed on Jan. 18, 2002.

(51) Int. Cl. H01Q 1/36

(52) U.S. Cl. 343/895

(57) ABSTRACT

A self-resonant quadrifilar helix antenna is formed with four helical electrically conductive elements arranged in each of four quadrants about a common central axis. A coaxial feed extends along the common central axis of the four helical electrically conductive elements. Top ends of first and second ones of the four helical electrically conductive elements are connected to a center conductor of the coaxial feed, and top ends of third and fourth ones of the four helical electrically conductive elements are connected to a shield of the coaxial feed. The bottom ends of each of the four helical electrically conductive elements are electrically connected to the shield of the coaxial feed. This provides a very compact structure in which the coaxial feed serves as a support for the antenna.

### BACKGROUND OF THE INVENTION

1. Field of the Invention

The present invention generally relates to radio wave antennas and, more particularly, to a novel feed for a self-resonant, high frequency quadrifilar helix antenna.

2. Background Description

Quadrifilar helix antennas are among the smallest circularly polarized antennas available. They are used in applications ranging from wireless data communications to satellite communications (e.g., global positioning satellite (GPS) systems). Such antennas may also be used in short range data communications (implementing, for example, the Bluetooth standard) which has the potential to be very high volume.

Traditional feed methods for quadrifilar helix antennas are difficult to implement at higher frequencies where the physical size of the helix is small. One potential application for this type of antenna is in a wireless local area network (WLAN), such as the Institute of Electrical and Electronics Engineers (IEEE) 802.11 standard and the Bluetooth standard.

A prior self-resonant quadrifilar helix antenna uses the two loops forming the quadrifilar helix which are electrically isolated at the end opposite from the feedpoint. This makes it difficult to construct the helix windings and still route the coaxial feedline to the feedpoint at the top of the antenna. This problem is exacerbated for small helix antennas which operate at high frequencies.

### SUMMARY OF THE INVENTION

It is therefore an object of the present invention to provide a novel feed structure for small self-resonant quadrifilar helix antennas which avoids the problems of the prior antennas.

According to the invention, the loops of the quadrifilar helix antenna are electrically connected to each other and the feed coaxial shield at the point on the loops opposite the feedpoint. We have discovered that this connection does not significantly affect the radiation properties of the antenna. The connection at the bottom of the quadrifilar helix antenna allows the coaxial line to function as a structural support for the antenna as well as the feed line.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic representation of a quadrifilar helix antenna showing the novel feed structure according to the present invention;

FIG. 2 is a cross-sectional view of the quadrifilar helix antenna of FIG. 1 showing the top feed;

FIG. 3 is a cross-sectional view of the quadrifilar helix antenna of FIG. 1 showing the bottom connections;

FIG. 4 is plot of the antenna radiation measured at a frequency of 2.50 Ghz;

FIG. 5 is a plot of the axial ratio of the quadrifillar helix measured in two orthogonal planes;

FIG. 6 is a plot of the data in FIG. 5 in rectangular format; and

FIG. 7 is a plot of the impedance match of the quadrifillar helix.

### DETAILED DESCRIPTION OF A PREFERRED EMBODIMENT OF THE INVENTION

The invention is for an improved feed configuration for a self-resonant quadrifilar helical antenna that allows the feeding coaxial cable to be integrated into the structural support of the helix that forms the antenna. Quadrifilar helix antennas are used in applications where circular polarization is required over a very wide beamwidth. The radiation pattern of a self-resonant quadrifilar helix antenna is close to omnidirectional.

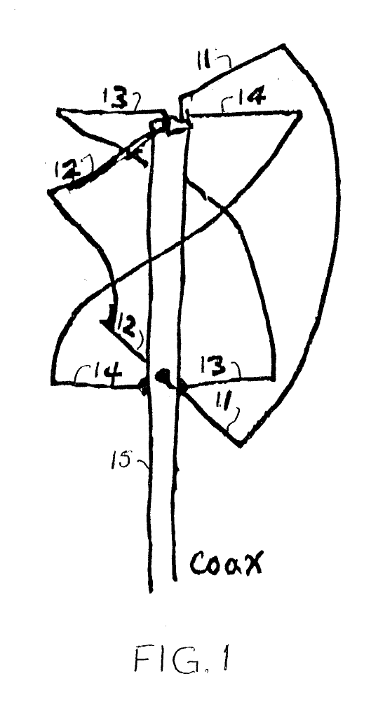

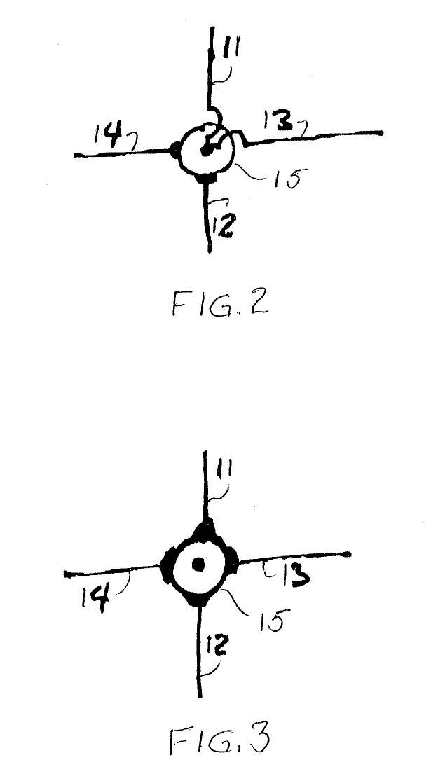

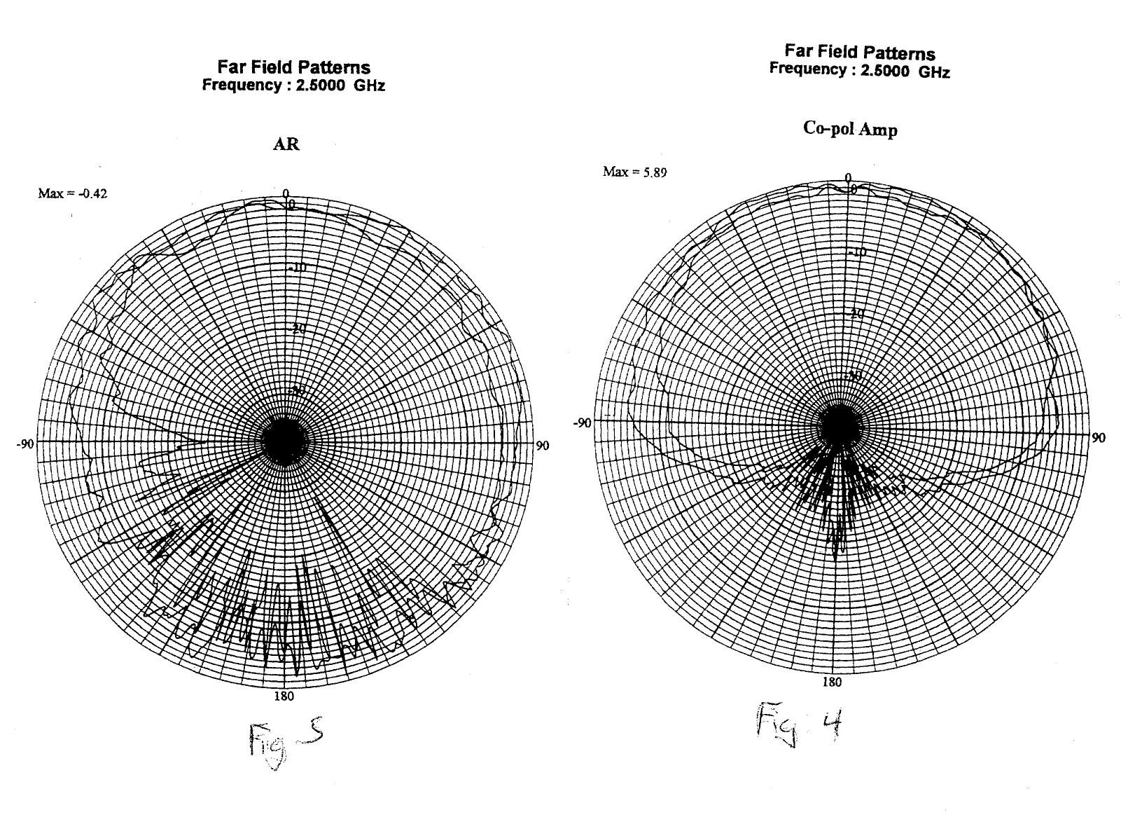

Referring now to the drawings, and more particularly to FIG. 1, there is shown a schematic representation of a quadrifilar helix antenna incorporating the novel feed structure according to the invention. The antenna comprises four conductive helices 11, 12, 13, and 14, which constitute the basic antenna. These four helices are supported by the coaxial feed 15. More particularly, and as shown in FIG. 2, the tops of the conductive helices 11 and 13, which are at right angles to one another, are electrically connected to the coaxial cable center conductor, and the tops of the conductive helices 12 and 14, which are at right angles to one another, are electrically connected to the coaxial cable shield. As shown in FIG. 3, the bottoms of each of the conductive helices 11, 12, 13, and 14 are electrically connected to the shield of the coaxial cable 15.

This feed allows for a very compact structure, which is important for small antennas operating at high frequencies. Not only does this feed not interfere with the basic antenna structure, but it also provides the basic support for the antenna structure.

A prototype of the quadrifilar helix with novel feed structure was measured for antenna impedance, pattern and axial ratio performance. The quadrifilar helix antenna produces a wide beamwidth (>90°) pattern that is circularly polarized. Usually the two “loops” making up the quadrifilar helix are not electrically connected at the ends opposite the feedpoint. In any antenna producing circular polarization, the magnitude and phases of the currents on the antenna structure are critical to maintaining the quality of the circular polarization, which is measured by the axial ratio (AR) of the antenna. By examining the antenna pattern and axial ratio performance, the effect of the feed structure on antenna performance can be inferred.

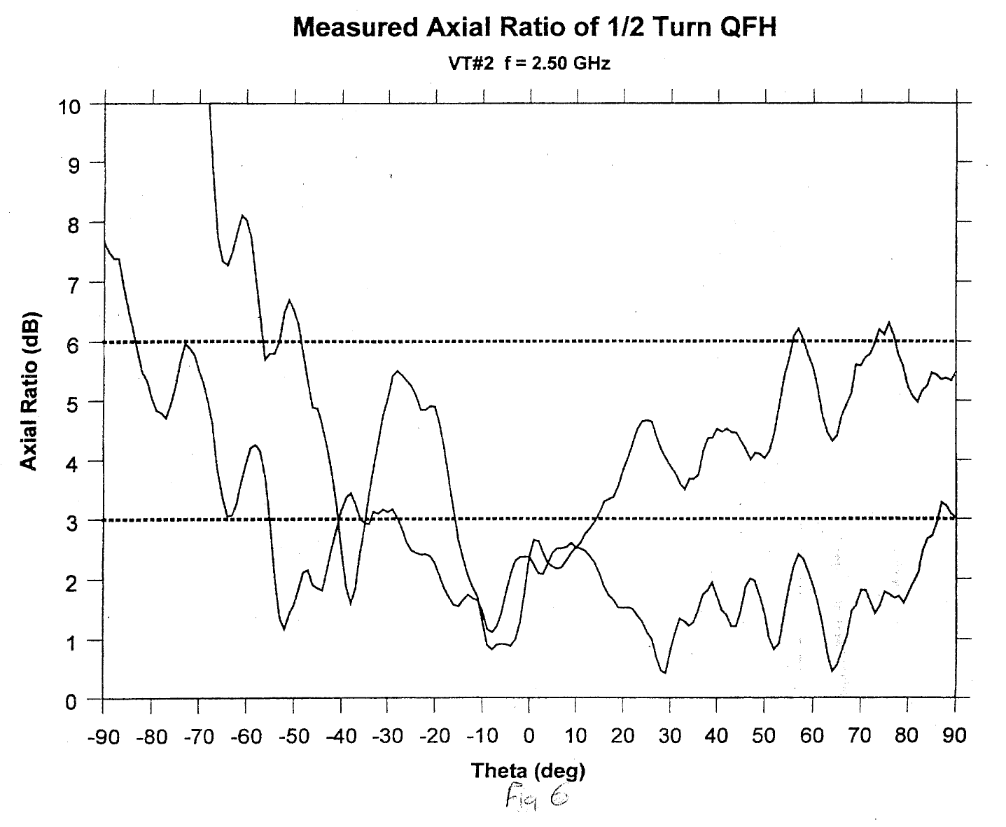

FIG. 5 is a plot of the antenna radiation pattern measured at a frequency fo 2.50 Ghz. The two lines show the antenna pattern measured in two orthogonal planes. Although there is some asymmetry between the two planes, the pattern is essentially the same and is typical of what is expected for a quadrifilar helix antenna.

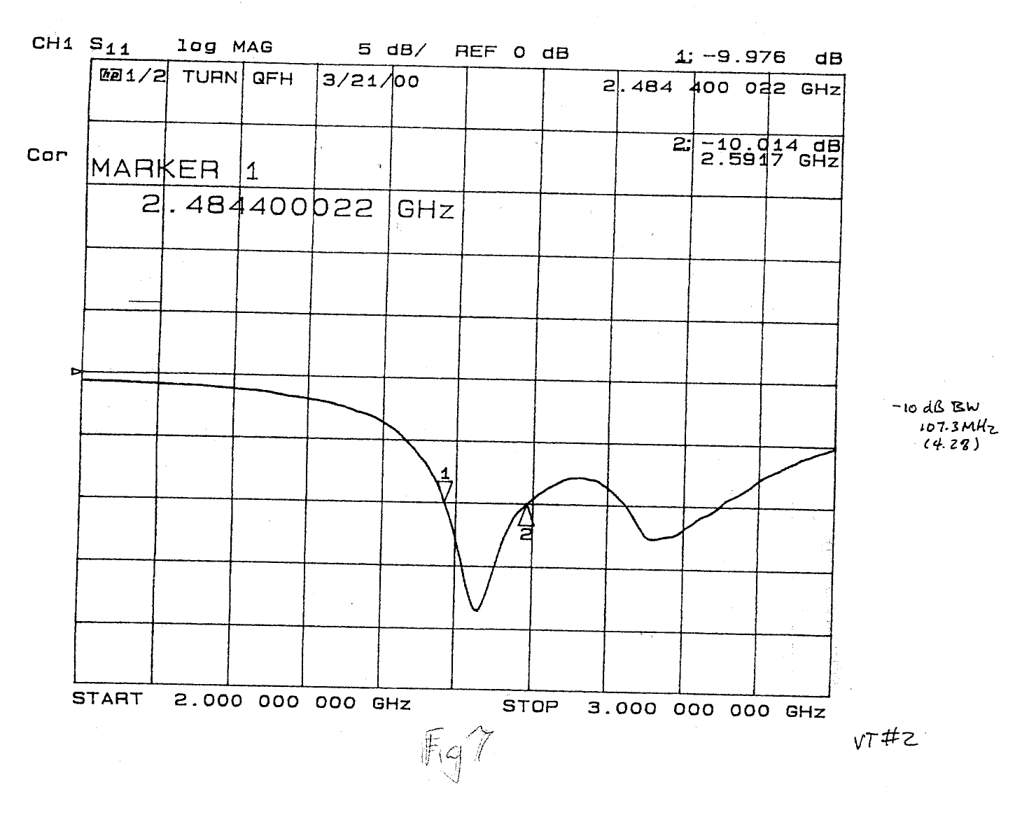

FIG. 6 is a plot of the axial ratio of the quadrifilar helix, again measured in two orthogonal planes. Typically, an axial ratio of −3 dB or less is considered highly desirable, but larger axial ratios are acceptable depending on the application. FIG. 6 shows good axial ratio over most of the upper hemisphere. FIG. 7 shows the same data as FIG. 6, but in rectangular format and with reference lines for axial ratios of 3 and 6 dB.

FIG. 7 shows the impedance match of the quadrifilar helix, indicating that this is a resonant antenna structure with a impedance match optimized at approximately 2.45 GHz.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A self-resonant quadrifilar helix antenna comprising:
four helical electrically conductive elements arranged in each of four quadrants about a common central axis;
a coaxial feed extending along the common central axis of the four helical electrically conductive elements, top ends of first and second ones of the four helical electrically conductive elements being connected to a center conductor of the coaxial feed and top ends of third and fourth ones of the four helical electrically conductive elements being connected to a shield of the coaxial feed, said third and fourth ones of the four helical electrically conductive elements being opposed to said first and second ones of the four helical electrically conducive elements, and bottom ends of each of the four helical electrically conductive elements being electrically connected to the shield of the coaxial feed, the coaxial feed serving as a support for the antenna.
